(19) United States
(12) Patent Application Publication
(10) Pub. No.: US 2026/0314528 A1
(43) Pub. Date: Oct. 15, 2026

(54) AGRICULTURAL SOIL CULTIVATION DEVICE

(71) Applicant: LEMKEN GmbH & Co. KG, Alpen (DE)

(72) Inventor: Andreas VAN KANN, Dahlem (DE)

(73) Assignee: LEMKEN GmbH & Co. KG, Alpen (DE)

(21) Appl. No.: 19/111,059

(22) PCT Filed: Sep. 8, 2023
(86) PCT No.: PCT/DE2023/100668

§ 371 Date: Mar. 12, 2025

(30) Foreign Application Priority Data
Sep. 15, 2022 (DE) 10 2022 123 565.3

(51) Int. Cl. A01C 7/20; A01C 5/06

(52) U.S. Cl. CPC A01C 7/203; A01C 5/064

(57) ABSTRACT

An agricultural soil cultivation device includes a height-adjustable support, on which at least one soil cultivation unit, which comprises a soil cultivation tool and a depth guide arranged adjacent to the soil cultivation tool is arranged by a four-bar linkage. The support is articulated on a frame of the soil cultivation device by a link mechanism including an upper link and a lower link. On the support a link is arranged, which extends in the direction of the depth guide. The link at its free end comprises a pivot point located in the contact region of the depth guide, in which a coupling element is articulated with one end. The coupling element with its other end is articulated in a pivot point arranged spaced apart above the pivot point of the link, which is fixed in place relative to the pivot point arranged on the link.

### CROSS-REFERENCE TO RELATED APPLICATION

This application is a national stage application, filed under 35 U.S.C. § 371, of International Patent Application PCT/DE2023/100668, filed on Sep. 8, 2023, which claims the benefit of German Patent Application DE 10 2022 123 565.3, filed on Sep. 15, 2022.

### TECHNICAL FIELD

The present disclosure relates to an agricultural soil cultivation device.

### BACKGROUND

An agricultural soil cultivation device is known from DE 196 44 751 A1. The agricultural soil cultivation device embodied as sowing machine includes a height-adjustable support, on which at least one soil cultivation unit, which comprises a soil cultivation tool and a depth guide arranged adjacent to the soil cultivation tool, is arranged by means of a four-bar linkage. The support is articulated on a frame of the soil cultivation device by means of a further link mechanism including an upper link and a lower link. At least the four-bar linkage, which connects the soil cultivation unit to the support, is embodied so as to converge in the travelling direction of the soil cultivation device. The position of upper link and lower link of the link mechanism relative to one another is adjustable between a parallel arrangement and a converging arrangement. Through a height adjustment of the link mechanism, a depth adjustment of the soil cultivation tool can be achieved by way of a tilting movement of the support about its longitudinal axis. The arrangement of the additional link mechanism proposed according to the prior art, with which the soil cultivation unit is directly arranged on the frame, below a hopper arranged on the frame, is unfavourable because of the additional installation space requirement.

### SUMMARY

An object of the disclosure is based on further developing an agricultural soil cultivation device of the type mentioned at the outset, which avoids the disadvantages of the prior art, in particular is characterised by a reduced installation space requirement and a more precise and comfortable adjustment.

This object is achieved through an agricultural soil cultivation device as disclosed and claimed.

An agricultural soil cultivation device is proposed, including a height-adjustable support, on which at least one soil cultivation unit is arranged, which comprises at least one soil cultivation tool and a depth guide arranged adjacent to the soil cultivation tool. The at least one soil cultivation unit is arranged on the support by means of a four-bar linkage, wherein the support is articulated on a frame of the soil cultivation device by means of a link mechanism including an upper link and a lower link. It is provided that on the support a link is arranged, which in portions extends in the direction of the depth guide, wherein the link at its free end comprises a pivot point located in the contact region of the depth guide, in which a coupling element is articulated with one end, wherein the coupling element with its other end is articulated in a pivot point arranged spaced apart above the pivot point of the link, which is fixed in place relative to the pivot point arranged on the link.

Substantial is the consideration of realising in the contact region a physical pivot point above the depth guide about which the soil cultivation unit arranged on the four-bar linkage is pivotable on a circular path. To this end, the link, at its free end, comprises the pivot point located in the contact region of the depth guide. Since a singular pivot point behind the at least one soil cultivation tool would result in a pushed arrangement, the coupling element is provided. The coupling element connects the pivot point located in the contact region of the depth guide to the pivot point arranged spaced apart above the pivot point of the link, which is fixed in place relative to the pivot point arranged on the link. In the process, the coupling element absorbs only vertical forces.

The spatial arrangement of the four-bar linkage and of the link mechanism is substantially parallel to one another, wherein the link mechanism and the four-bar linkage arranged so as to overlap one another. Emanating from the frame, the link mechanism extends in the direction of the at least one soil cultivation unit.

In particular, the upper link of the link mechanism can be articulated on the frame with one end and with its opposite end, extend within the contact region as far as to above the depth guide, wherein the link with its frame-side end, is non-rotatably arranged on the support.

To this end, the pivot point that is fixed in place relative to the pivot point arranged on the link can be arranged on the upper pivot point. The position of the pivot point on the upper link, which is pivotable about a frame-side pivot point, remains unchanged even when pivoting relative to the pivot point arranged on the link.

According to an alternative embodiment, the upper link of the link mechanism can be embodied as vertical link, with one end is arranged fixed in place on the frame and with its opposite end is articulated in a pivot point on the support. According to this embodiment, the link is also non-rotatably arranged with its frame-side end on the support. With this embodiment, the upper link embodied as vertical link can be designed so as to be variable in length. To this end, the vertical link can be designed as linear actuator, for example, as spindle, spindle motor or hydraulic cylinder.

To this end, the pivot point arranged fixed in place relative to the pivot point arranged on the link can be arranged on a portion of the frame extending into the contact region. The pivot point fixed in place relative to the pivot point arranged on the link is arranged fixed in place on the frame.

The upper link embodied as vertical link can be equipped for adjusting an engagement depth of the soil cultivation tool. In particular, the embodiment as linear actuator makes possible an adjustment of the engagement depth of the soil cultivation tool, in that the distance of the support to the ground is achieved by a change in length of the vertical link.

Preferably, the lower link can comprise a frame-side pivot point and a support-side pivot point. The lower link can be assigned the function of transmitting tensile forces to the support and the at least one soil cultivation unit arranged thereon.

According to a further development, at least one adjusting means can be provided, which is equipped for adjusting an engagement depth of the soil cultivation tool and/or for adjusting a pressure to be exerted on a ground by the soil cultivation tool. Thus, through the at least one adjusting means with a soil cultivation device embodied as sowing machine, the seeding depth and/or a coulter pressure can be adjusted.

To this end, the at least one adjusting means can be embodied as linear actuator. The adjusting means can be embodied as hydraulic cylinder, spindle, spindle motor or linear motor. With an embodiment as spindle, the same can be manually or automatically actuatable.

In particular, the coupling element can be embodied so as to be variable in length. The coupling element can be embodied as hydraulic cylinder. In particular, the coupling element can be embodied as double-acting hydraulic cylinder.

Preferably, joints with at least 1° of freedom can be arranged in the pivot points. The joints can be embodied, for example, as pivot joint or as ball joint.

According to a preferred further development, the components of the four-bar linkage and of the link mechanism pivotably connected to one another in the pivot points can each be embodied so as to be detachable from one another.

In the following, the present invention is explained in more detail by way of exemplary embodiments shown in the drawings, wherein same reference signs relate to same or similar or functionally same components.

### BRIEF DESCRIPTION OF THE DRAWINGS

FIG. 1: schematically and exemplarily an agricultural soil cultivation device according to the prior art;

FIG. 2: schematically and exemplarily a lateral view of a soil cultivation unit of an agricultural soil cultivation device according to the invention;

FIG. 3: schematically and exemplarily a lateral view of the soil cultivation unit according to FIG. 2 in a deviating working position;

FIG. 4: schematically and exemplarily a lateral view of the soil cultivation unit according to FIG. 3 in a further deviating working position;

FIG. 5: schematically and exemplarily a lateral view of a further embodiment of the soil cultivation unit;

FIG. 6: schematically and exemplarily a lateral view of the soil cultivation unit according to FIG. 5 in deviating working position; and

FIG. 7: schematically and exemplarily a lateral view of the soil cultivation unit according to FIG. 6 in a further deviating working position.

### DETAILED DESCRIPTION

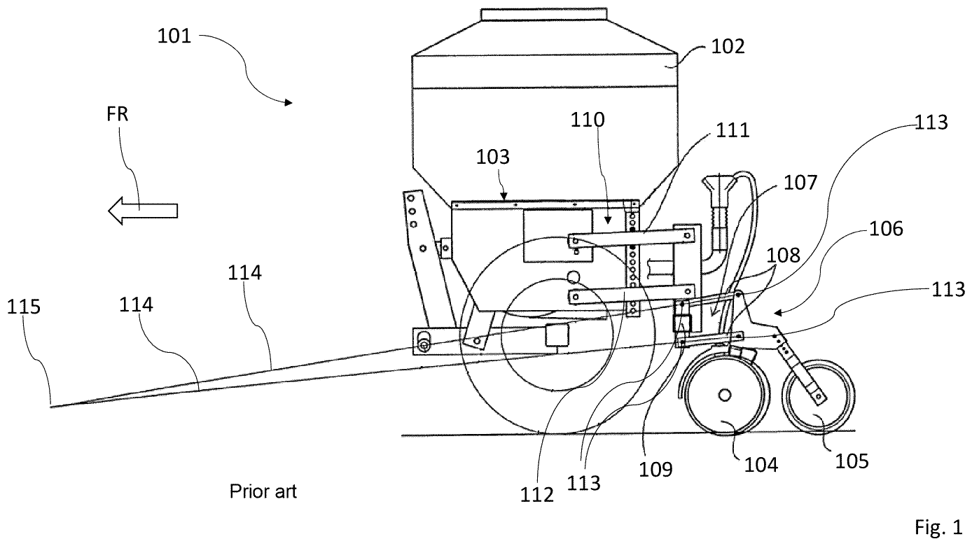

FIG. 1 shows schematically and exemplarily an agricultural soil cultivation device 101 embodied as agricultural seed drill according to the prior art. The soil cultivation device 101 can also be embodied as hoeing machine. The soil cultivation device 101 includes a hopper 102 receiving seeds and/or fertiliser and a frame 103 carrying the hopper 102. A soil cultivation unit 106 is indirectly articulated on the frame 103. The soil cultivation unit 106 includes a soil cultivation tool 104 and a depth guide 105. According to the representation in FIG. 1, the soil cultivation tool 104 is a seed coulter and the depth guide 105 is a depth guiding roller.

The soil cultivation unit 106 is connected via a four-bar linkage 107 with links 108, which are arranged so as to converge in the travelling direction FR, to a support 109. The support 109 in turn is connected through a further link mechanism 110 with an upper link 111 and a lower link 112, to the frame 103 of the soil cultivation device 101.

The links 108 each comprise two end-side pivot points 113, on which the respective link 108 is articulated on the support 109 or on a frame element of the soil cultivation unit 106. The auxiliary lines 114 running through the two pivot points 113 of the respective link 108, because of their arrangement converging in the travelling direction FR, have a common intersection point, which is referred to as virtual pivot point 115 of the four-bar linkage 107.

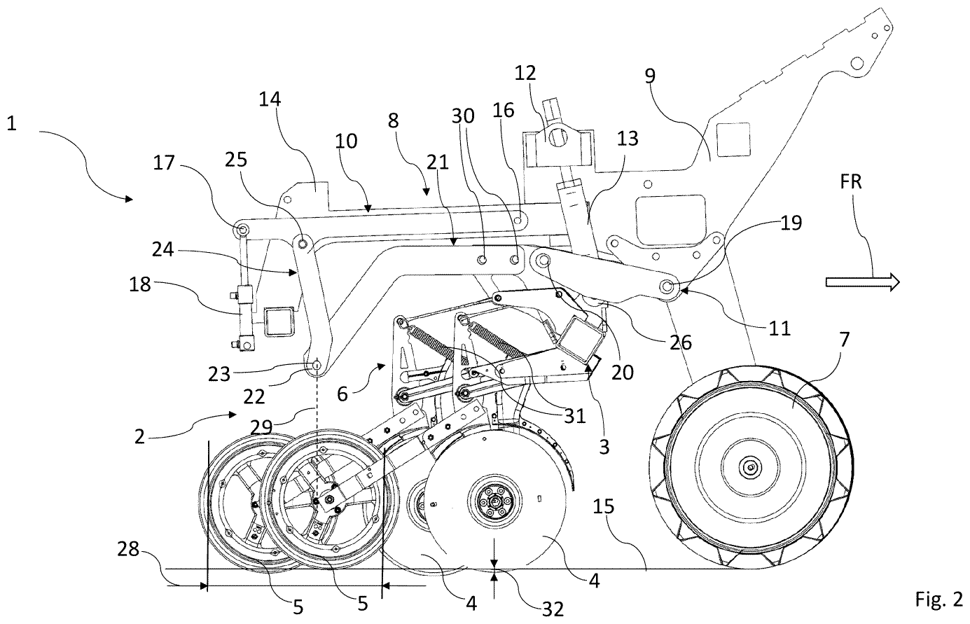

FIG. 2 shows schematically and exemplarily a lateral view of a soil cultivation unit 2 of an agricultural soil cultivation device 1 according to the invention. The soil cultivation device 1 includes multiple soil cultivation units 2 arranged next to one another, which are arranged on a support 3.

The soil cultivation device 1 includes the height-adjustable support 3, on which the at least one soil cultivation unit 2 is arranged. The soil cultivation unit 2 comprises a soil cultivation tool 4 and a depth guide 5 arranged spaced apart from the soil cultivation tool 4. The soil cultivation unit 2 is arranged on the support 3 by means of a four-bar linkage 6. Furthermore, a roller or roll following a ground contour can be arranged before or after a soil cultivation unit 2. In the shown exemplary embodiment, a packer roller 7 is arranged ahead of the soil cultivation unit 2 seen in the travelling direction FR.

In the shown exemplary embodiment, the soil cultivation tool 4 is embodied as seed coulter, in particular as double-disc coulter. The soil cultivation tool 4 can also be embodied as hoeing tool, for example.

Here and preferentially, the depth guide 5 is embodied as depth guiding roller. The depth guide 5 can also be embodied, for example, as support wheel, skid or the like.

The support 3 is articulated by means of a link mechanism 8 on a frame 9 or a hopper for seeds and/or fertiliser of the soil cultivation device 1. The link mechanism 8 includes an upper link 10 and a lower link 11.

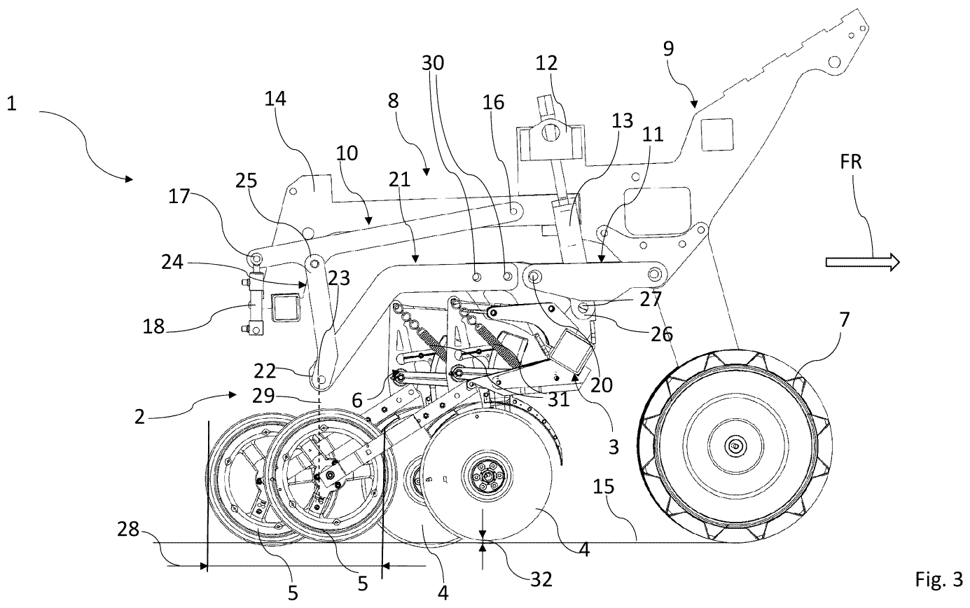

On a frame segment 12 of the frame 9 formed above the support 3, an adjusting means 13 is arranged. With a support-side portion 26, the adjusting means 13 is articulated in a third pivot point 27, as shown in FIG. 3. Here and preferentially, the adjusting means 13 is embodied as linear actuator. To this end, the adjusting means 13 can be embodied as hydraulic cylinder, spindle, spindle motor or linear motor. By actuating the adjusting means 13, an engagement depth 32 of the soil cultivation tools 4, in the case of the soil cultivation device 1 being embodied as seed, the sowing depth can be adjusted. In addition, by actuating the adjusting means 13, a pressure exerted by the soil cultivation tools 4 on the ground 15 can be varied.

The frame 9 comprises a frame element 14 extending opposite to the travelling direction FR, which runs substantially parallel to the ground 15. One end of the upper link 10 is pivotably articulated on the frame element 14 in the pivot point 16. With its opposite end, the upper link 10 is articulated in the pivot point 17 on an adjusting means 18. The adjusting means 18 is arranged fixed in place on the frame element 14.

Here and preferentially, the adjusting means 18 is embodied as linear actuator. To this end, the adjusting means 18 can be embodied as hydraulic cylinder or linear motor. By actuating the adjusting means 18, the upper link 10 can be pivoted about its frame-side pivot point 16. Interacting with the adjusting means 13, the adjusting means 18 can change the pressure exerted by the soil cultivation tools 4 on the ground. Additionally or alternatively, the engagement depth 32 of the soil cultivation tools 4 can be changed by actuating the adjusting means 18.

The lower link 11 is pivotably articulated in the frame-side pivot point 19 on the frame 9 with its frame-side end. With its support-side end, the lower link 11 is articulated in the support-side pivot point 20 on the support 3. On the support 3, a link 21 is arranged which extends opposite to the travelling direction FR in portions in the direction of the depth guide 5. With its support-side end, the link 21 is arranged on the support 3 fixed in place. To this end, the link 21 can be fastened to the support 3 with screw connections 30. At its free end 22, the link 21 comprises a first pivot point 23.

The first pivot point 23 of the link 21 is located in a contact region 28 above the depth guide 5. The contact region 28 refers to the region of the ground 15 which is covered, seen in the travelling direction FR, by the depth guide 5. To illustrate the position of the first pivot point 23 of the link 21, a dashed auxiliary line 29 is drawn in which, running through the first pivot point 23, extends perpendicularly to the ground 15 and is located in the contact region 28. On the first pivot point 23, a coupling element 24 is articulated, which is articulated in a second pivot point 25 on the upper link 10. Here and preferentially, the coupling element 24 is articulated with the frame-side end in the second pivot point 25 of the upper link 10 arranged spaced apart above the first pivot point 23 of the link 21. The second pivot point 25 is fixed in place relative to the first pivot point 23 arranged on the link 21. Here and preferentially, the coupling element 24 is embodied as two-point link.

Since a singular pivot point behind the at least one soil cultivation tool 4 would result in a pushed arrangement, the coupling element 24 is provided. The coupling element 24 connects the first pivot point 23 located in the contact region 28 of the depth guide 5 with the second pivot point 25 arranged spaced apart above the first pivot point 23 of the link 21, which is fixed in place relative to the first pivot point 23 arranged on the link 21. The coupling element 24 only absorbs vertical forces.

An adjustment of the upper link 10 by the adjusting means 18 causes an actuation of the link mechanism 8.

The four-bar linkage 6 can comprise energy stores, here and preferentially springs 31. The springs 31 are arranged so as to exert a downward hyphen directed force onto the soil cultivation tool 4 and the depth guide 5. Thus, the pressure load exerted by the soil cultivation tool 4 and the depth guide 5 can be influenced. The spring force or the spring preload can be easily adjusted by changing the spring length or by simply reconnecting the springs 31 as indicated in FIG. 3.

The representation in FIG. 2 shows the soil cultivation unit 2 in an exemplary working position preset by the adjusting means 13, 18, in which the soil cultivation tools 4 have a low engagement depth 32 and the depth guide 5 exerts a low pressure on the ground 15.

In FIG. 3, a lateral view of the soil cultivation unit 2 according to FIG. 2 is schematically and exemplarily shown in a deviating working position. In the shown working position, the soil cultivation tool 4, furthermore, has a low engagement depth 32. However, the pressure exerted on the ground 15 by the depth guide 5 is increased. This is achieved in that the adjusting means 18 is completely retracted so that the upper link 10 is pivoted about its frame-side pivot point 16 in the direction 15 of the ground. The spatial position of the first pivot point 23 moving on a circular path within the contact region 28 remains substantially unchanged. Tracking of the adjusting means 13 is effected in the manner that the engagement depth 32 relative to the working position shown in FIG. 2 does not change. The lower link 11 and the link 21 are transferred by the adjusting means 13 into a position approximately aligned in the horizontal direction relative to one another.

By retracting the adjusting means 18, the upper link 10 is pivoted in the direction of the ground 15. The coupling element 24 transmits this movement in the vertical direction to the link 21. The link 21 fastened to the support 3 moves the support 3 accordingly in the direction of the ground 15.

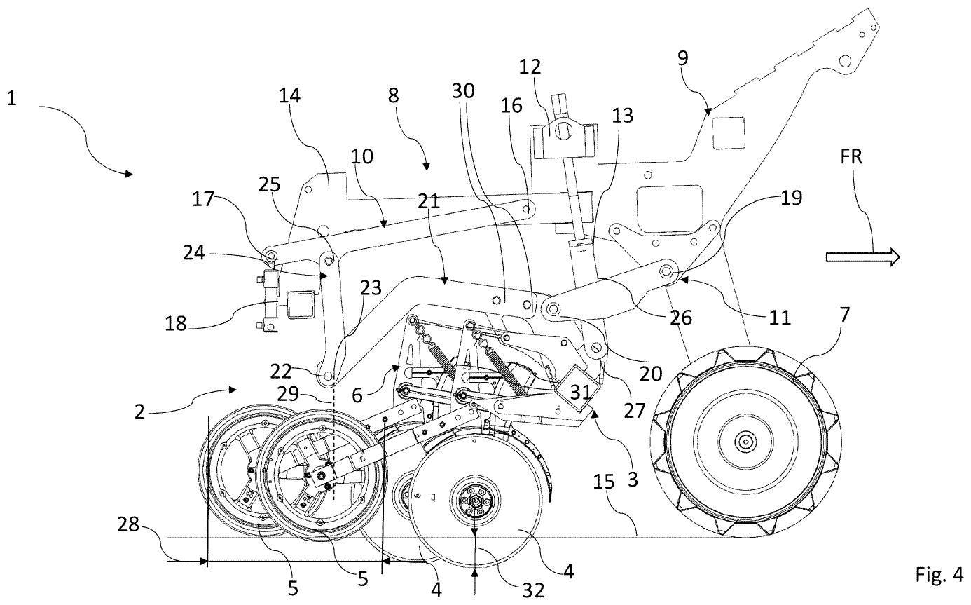

FIG. 4 shows schematically and exemplarily a lateral view of the soil cultivation unit according to FIG. 3 in a working position deviating therefrom. In contrast with the working position shown in FIG. 3, the adjusting means 13 in the working position according to FIG. 4 is completely extended so that a change of the penetration depth of the soil cultivation tool 4 additionally materialises. The representation in FIG. 4 shows the soil cultivation unit 2 in a working position preset by the adjusting means 13, 18, in which the soil cultivation tools 4 have a greater engagement depth 32 and the depth guide 5 exerts a greater pressure on the ground 15.

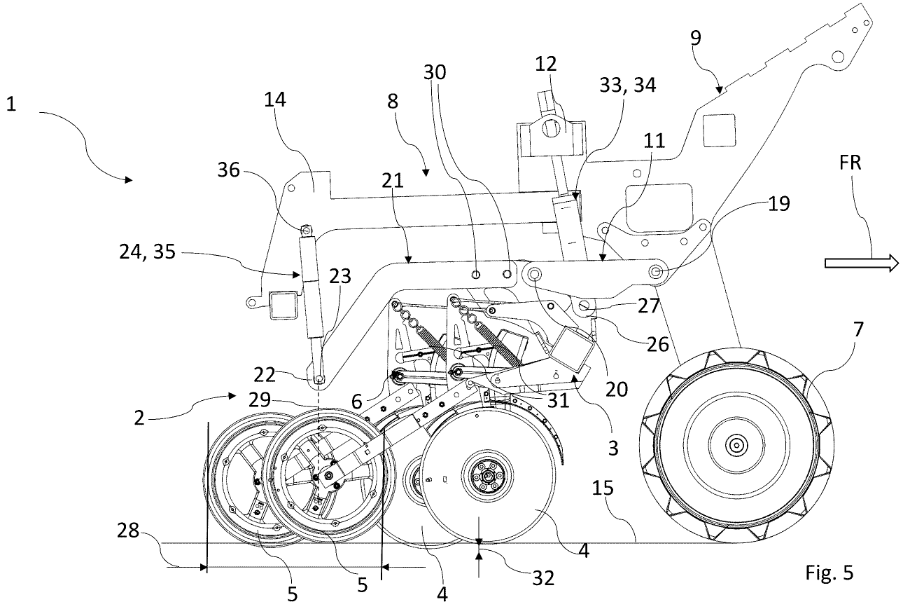

The representation in FIG. 5 shows schematically and exemplarily a lateral view of a further embodiment of the soil cultivation unit 2. The general construction corresponds to the soil cultivation unit 2 shown in FIG. 2 to 4. In the following, only the existing differences of the further embodiment of the soil cultivation unit 2 shown in FIG. 5 are explained.

A first difference consists in that instead of the separate upper link 10 of the link mechanism 8 articulated on the frame 9, an upper link 33 embodied as vertical link 34 is provided. The upper link 33 or vertical link 34 can be identical with the embodiment of the adjusting means 13. The vertical link 34 is embodied so as to be variable in length. In particular, the vertical link 34 can be embodied as linear actuator, for example, as cylinder or spindle. This means that the adjusting means 13 additionally assumes the function of the upper link 33 of the link mechanism 8. In contrast with the upper link 10, the upper link 33 according to the embodiment described further up is fastened to the frame segment 12 of the frame 9, which is formed above the support 3. With its support-side portion 26, the upper link 33 is articulated in the third pivot point 27 on the support 3.

According to this embodiment, the coupling element 24 is embodied so as to be variable in length as a further difference, for example, as hydraulic cylinder 35. Here and preferentially, the coupling element 24 is articulated with the frame-side end with a second pivot point 36 arranged spaced apart above the first pivot point 23 of the link 21 on the frame element 14. The second pivot point 36 is fixed in place relative to the first pivot point 23 arranged on the link 21. In contrast with the second pivot point 25 on the upper link 10 that is relatively movable relative to the frame 9, the second pivot point 36 is arranged fixed in place on the frame 9. The second pivot point 36 fixed in place is arranged on a portion of the frame element 14 extending into the contact region 28.

The coupling element 24 embodied so as to be variable in length can, besides its function described further up, additionally assume the function of the adjusting means 18.

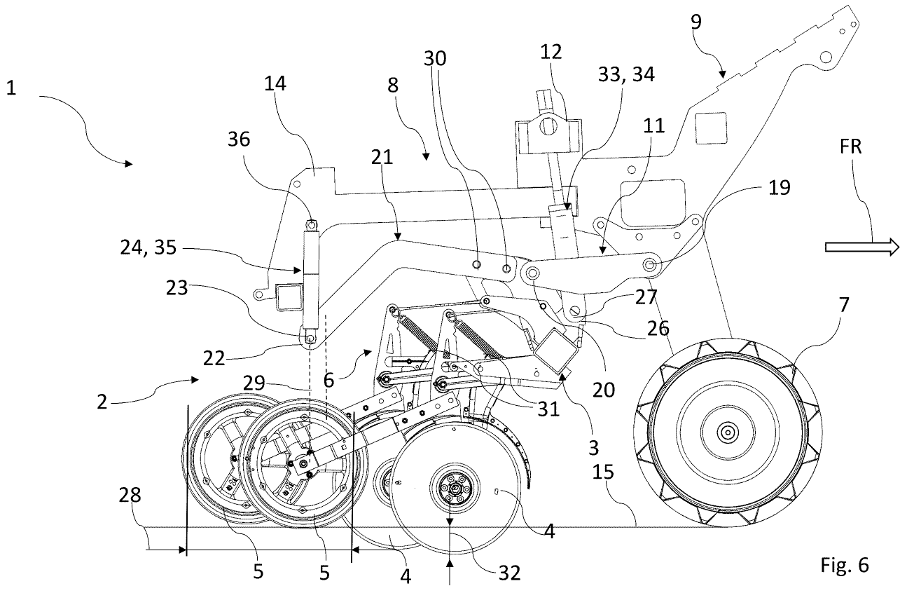

In FIG. 6, a lateral view of the soil cultivation unit 2 according to FIG. 5 is schematically and exemplarily shown in a deviating working position. In the shown working position, the soil cultivation tool 4 has a greater engagement depth 32. This is achieved in that the coupling element 24 is completely retracted so that the link 10 with its first pivot point 23 is transferred into a position further spaced apart relative to the ground 15 in the vertical direction. The spatial position of the first pivot point 23 moving on a circular path within the contact region 28 remains substantially unchanged. Tracking of the vertical link 34 embodied as adjusting means is effected through partial extending in the manner that the engagement depth 32 relative to the working position of the soil cultivation unit 2 shown in FIG. 5, increases. The lower link 11 is transferred through the adjusting cylinder 34 in a position inclined relative to the horizontal. The support 3 is transferred by the adjusting cylinder 34 for increasing the engagement depth 32 in the vertical direction into a position which is spaced apart to a lesser extent relative to the ground 15.

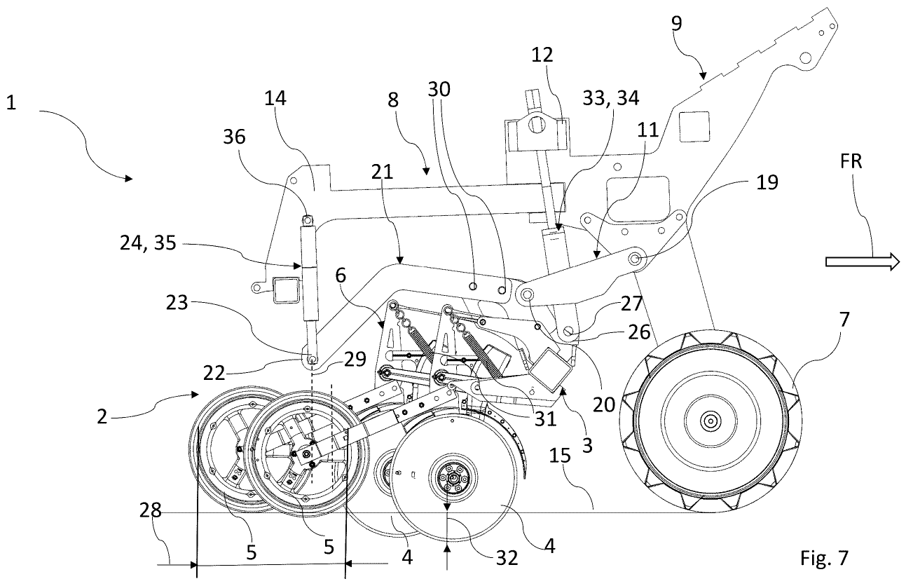

The representation in FIG. 7 shows schematically and exemplarily a lateral view of the soil cultivation unit 2 according to FIG. 6 in a working position further deviating therefrom. The adjusting means embodied as adjusting cylinder 34 is shown completely extended, which corresponds to the maximum engagement depth 32. In addition, the coupling element 24 is completely extended, as a result of which the depth guide 5 exerts a greater pressure on the ground 15.

In the illustrated embodiments it is substantial that the position of the first pivot point 23, in which the link 21 and the coupling element 24 are connected to one another in an articulated manner always remains in the contact region 28. Through the arrangement of the link mechanism 8 and the four-bar linkage 6 substantially overlapping one another on the frame 9 and the extension against the travelling direction FR behind the packer roller 7, an installation space optimisation is achieved relative to the prior art. At the same time, a simple, comfortable and precise adjustment of the soil cultivation unit 2 is possible. Both the engagement depth 43 and also the pressure exerted on the ground 15 can be comfortably and precisely adjusted.

LIST OF REFERENCE NUMBERS
1 Soil cultivation device
2 Soil cultivation unit
3 Support
4 Soil cultivation tool
5 Depth guide
6 Four-bar linkage
7 Packer roller
8 Link mechanism
9 Frame
10 Upper link
11 Lower link
12 Frame segment
13 Adjusting means
14 Frame element
15 Ground
16 Pivot point
17 Pivot point
18 Adjusting means
19 Frame-side pivot point
20 Support-side pivot point
21 Link
22 Free end of 21
23 First pivot point
24 Coupling element
25 Second pivot point
26 Portion
27 Third pivot point
28 Contact region
29 Auxiliary line
30 Screw connection
31 Spring
32 Engagement depth
33 Upper link
34 Vertical link
35 Hydraulic cylinder
36 Second pivot point (fixed)
FR Travelling direction
101 Soil cultivation device
102 Hopper
103 Frame
104 Soil cultivation tool
105 Depth guide
106 Soil cultivation unit
107 Four-bar linkage
108 Link
109 Support
110 Link mechanism
111 Upper link
112 Lower link
113 Pivot point
114 Auxiliary line
115 Virtual fulcrum

1.-12. (canceled)

13. An agricultural soil cultivation device (1), comprising:
a frame (9);
a height-adjustable support (3); and
a soil cultivation unit (2) arranged on the height-adjustable support (3) by a four-bar linkage (6),
wherein the soil cultivation unit (2) comprises
a soil cultivation tool (4), and
a depth guide (5) arranged adjacent to the soil cultivation tool (4),
wherein the height-adjustable support (3) is articulated on the frame (9) by a link mechanism (8),
wherein the link mechanism (8) includes an upper link (10, 33) and a lower link (11),
wherein a link (21) is arranged on the height-adjustable support (3),
wherein the link (21) extends toward the depth guide (5),
wherein the link (21) comprises a first pivot point (23) located at a free end (22) of the link (21) in a contact region (28) of the depth guide (5),
wherein a coupling element (24) is articulated with one end in the first pivot point (23),
wherein the coupling element (24) is articulated with another end in a second pivot point (25, 36) arranged spaced apart above the first pivot point (23) of the link (21),
wherein the second pivot point (25, 36) is fixed in place relative to the first pivot point (23) arranged on the link (21).

14. The agricultural soil cultivation device (1) according to claim 13,
wherein the upper link (10) is articulated on the frame (9) with one end and extends within the contact region (28) above the depth guide (5) with an opposite end, and
wherein the link (21) is non-rotatably arranged on the height-adjustable support (3) with a frame-side end.

15. The agricultural soil cultivation device (1) according to claim 14,
wherein the fixed? second pivot point (25) is arranged on the upper link (10).

16. The agricultural soil cultivation device (1) according to claim 13,
wherein the upper link (33) is a vertical link (34), and
wherein one end of the vertical link (34) is fixedly arranged on the frame (9), and
wherein an opposite end of the vertical link (34) is articulated in a third pivot point (27) on the height-adjustable support (3).

17. The agricultural soil cultivation device (1) according to claim 14,
wherein the second pivot point (36) is arranged on a portion of the frame (9) extending into the contact region (28).

18. The agricultural soil cultivation device (1) according to claim 16,
wherein the vertical link (34) is configured for adjusting an engagement depth (32) of the soil cultivation tool (4).

19. The agricultural soil cultivation device (1) according to claim 13,
wherein the lower link (11) comprises a frame-side pivot point (19) and a support-side pivot point (20).

20. The agricultural soil cultivation device (1) according to claim 13,
further comprising at least one? an adjusting means (13, 18),
wherein the adjusting means (13, 18) is configured for adjusting an engagement depth (32) of the soil cultivation tool (4) and/or for adjusting a pressure exerted on a ground (15) by the soil cultivation tool (4).

21. The agricultural soil cultivation device (1) according to claim 20,
wherein the at least one? adjusting means (13, 18) is a linear actuator.

22. The agricultural soil cultivation device (1) according to claim 13,
wherein the coupling element (24) is variable in length.

23. The agricultural soil cultivation device (1) according to claim 19,
wherein a respective joint with at least one degree of freedom is arranged in each of the first pivot point (23), the second pivot point (25), the frame-side pivot point (19), and the support-side pivot point (20).

24. The agricultural soil cultivation device (1) according to claim 23,
wherein components of the four-bar linkage (6) and of the link mechanism (8) pivotably interconnected in the first pivot point (23), the second pivot point (25), the frame-side pivot point (19), and the support-side pivot point (20) are detachable from one another.
